(19) United States
(12) Patent Application Publication
(10) Pub. No.: US 2025/0324345 A1
(43) Pub. Date: Oct. 16, 2025

(54) SYSTEMS AND METHODS FOR HANDLING USER EQUIPMENT ROUTE SELECTION POLICY RULES

(71) Applicant: Verizon Patent and Licensing Inc., Basking Ridge, NJ (US)

(72) Inventors: Lixia YAN, Basking Ridge, NJ (US); Violeta CAKULEV, Milburn, NJ (US); Lalit R. KOTECHA, San Ramon, CA (US); Ce XU, Campbell, CA (US)

(73) Assignee: Verizon Patent and Licensing Inc., Basking Ridge, NJ (US)

(21) Appl. No.: 18/632,815

(22) Filed: Apr. 11, 2024

(51) Int. Cl. H04W 40/02; H04W 48/16

(52) U.S. Cl. CPC H04W 40/02; H04W 48/16

(57) ABSTRACT

In some implementations, a device may identify a user equipment (UE) route selection policy (URSP) rule to be provisioned for a UE. The device may transmit the URSP rule and an indicator, wherein the indicator indicates a UE behavior with respect to the URSP rule provisioned for the UE by the device and a preconfigured URSP rule stored at the UE.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of an example associated with handling user equipment (UE) route selection policy (URSP) rules.

FIG. 2 is a diagram of an example associated with handling URSP rules.

FIG. 3 is a diagram of an example associated with a URSP data structure.

FIG. 4 is a diagram of an example environment in which systems and/or methods described herein may be implemented.

FIG. 5 is a diagram of example components of one or more devices of FIG. 4.

FIG. 6 is a flowchart of an example process associated with handling URSP rules.

### DETAILED DESCRIPTION OF EXAMPLE EMBODIMENTS

The following detailed description of example implementations refers to the accompanying drawings. The same reference numbers in different drawings may identify the same or similar elements.

A UE may route traffic using URSP rules, which may be provisioned by a wireless network. The UE may assign UE traffic to packet data unit (PDU) sessions based on the URSP rules. The UE may locally store the URSP rules. For example, the URSP rules may be stored on a subscriber identification module (SIM) card or an embedded SIM (eSIM) card associated with the UE. The URSP rules may be network-generated URSP rules. A policy control function (PCF) (or UE-PCF) in the wireless network may generate the URSP rules and then push the URSP rules to the UE. Alternatively, the URSP rules may be preconfigured URSP rules. The preconfigured URSP rules may be created and stored on the UE during a UE, SIM, and/or eSIM manufacturing stage.

As an example, the UE may be associated with a first network slice. The first network slice may be associated with a first PDU session. The first PDU session may be associated with a data network name (DNN) set to “Premium” and an Internet Protocol (IP) address type set to “IPv4v6”. The UE may also be associated with a second network slice. The second network slice may be associated with a second PDU session and a third PDU session. The second PDU session may be associated with a DNN set to “IMS” (IP multimedia subsystem) and an IP address type set to “IPV6”. The third PDU session may be associated with a DNN set to “Internet” and an IP address type set to “IPv4v6”. A URSP for the UE may include a first URSP rule, a second URSP rule, and a third URSP rule. The first URSP rule may indicate that a first traffic type should be routed to the first packet data network (PDN) session (e.g., DNN=Premium, PDU type IPv4v6). The second URSP rule may indicate that a second traffic type should be routed to the second PDN session (e.g., DNN=IMS, PDU type IPV6). The third URSP rule may indicate that a third traffic type should be routed to the third PDN session (e.g., DNN=Internet, PDU type IPv4v6).

The URSP rules may be delivered from the PCF to the UE in accordance with a UE policy delivery procedure. The URSP rules may also be preconfigured in the UE. A preconfigured URSP rule may be applied by the UE only when the UE has not received the same type of URSP rule from the PCF (e.g., a URSP rule received from the PCF may have a higher priority than a preconfigured URSP rule). The URSP rules may be delivered from the PCF to a Fifth Generation residential gateway (5G-RG) or a wireless access gateway function (W-AGF) acting on behalf of a fixed network router gateway (FN-RG) in accordance with the UE policy delivery procedure. After the PCF provides URSP rules to the UE, the preconfigured URSP rules stored on the UE may no longer be active (e.g., the preconfigured URSP rules stored on the UE may become inactive upon receipt of the URSP rules from the PCF).

As an example, a subscriber may sign up for a premium data service. A unified data repository (UDR) may provision the premium data service into a data store associated with the UDR. The UDR may notify the PCF that the subscriber signed up for the premium data service. The PCF may provision a URSP rule associated with the premium data service (e.g., Premium-Data-URSP) to the UE. The UE may have a preconfigured URSP rule associated with WiFi calling (e.g., WiFi-URSP). After the UE receives, from the PCF, the URSP rule associated with the premium data service, the preconfigured URSP rule associated with WiFi calling may no longer be effective. As a result, the UE may no longer be able to perform WiFi calling.

In some cases, when the PCF provides the URSP rules to the UE, the PCF may also include the preconfigured URSP rules, so the UE does not lose the preconfigured URSP rules after receiving the URSP rules from the PCF.

As an example, the subscriber may sign up for the premium data service. The UDR may provision the premium data service into the data store associated with the UDR. The UDR may notify the PCF that the subscriber signed up for the premium data service. The PCF may provision two URSP rules to the UE. The PCF may provision the URSP rule associated with the premium data service (e.g., Premium-Data-URSP) to the UE. The PCF may also provision, along with the URSP rule associated with the premium data service, the preconfigured URSP rule associated with WiFi calling (e.g., WiFi-URSP). As a result, the UE may not lose the preconfigured URSP rule associated with WiFi calling when receiving the URSP rule associated with the premium data service.

In some cases, based on different chipset vendors, the preconfigured URSP rules may be different for different types of UEs. The PCF may be unaware of a type of UE that is used by the subscriber. When a failure occurs when the PCF pushes URSP rules to the UE (e.g., new URSP rules and preconfigured URSP rules), the UE may be unable to use the preconfigured URSP rules (e.g., the UE may be unable to perform WiFi calling).

As an example, the subscriber may sign up for the premium data service. The UDR may provision the premium data service into the data store associated with the UDR. The UDR may notify the PCF that the subscriber signed up for the premium data service. The PCF may provision two URSP rules to the UE. The PCF may provision the URSP rule associated with the premium data service (e.g., Premium-Data-URSP) to the UE. The PCF may also provision, along with the URSP rule associated with the premium data service, a preconfigured URSP rule associated with WiFi calling. However, the preconfigured URSP rule associated with WiFi calling may depend on the type of UE. For example, when the UE is associated with a first type, the preconfigured URSP rule associated with WiFi calling should be specific to the first type (e.g., WiFi-URSP-Type1). As another type, when the UE is associated with a second type, the preconfigured URSP rule associated with WiFi calling should be specific to the second type (e.g., WiFi-URSP-Type2). However, the preconfigured URSP rule associated with WiFi calling may be different for different types of UEs, and the PCF may not be able to distinguish the type of UE used by the subscriber. In this case, the PCF may be unable to determine whether to provide a first type or a second type of the preconfigured URSP rule associated with WiFi calling.

In some implementations, in a URSP data structure, a URSP may include a UE policy section management sub-list, and a byte may be added to the UE policy section management sub-list. A PCF may set a value of the byte before the PCF provides the URSP to a UE. The UE, after receiving the URSP, may check the value of the byte. When the byte is set to a first value (e.g., “00000000”), the UE may ignore a preconfigured URSP rule and only use a URSP rule from the PCF (e.g., the URSP rule pushed by the PCF). In other words, when the byte is set to the first value, the UE may override the preconfigured URSP rule with the URSP rule from the PCF. When the byte is set to a second value (e.g., “00000001”), the UE may combine (e.g., merge) the preconfigured URSP rule with the URSP rule from the PCF. The preconfigured URSP rule may have a higher priority than the URSP rule from the PCF. When the byte is set to a third value (e.g., “00000010”), the UE may combine the preconfigured URSP rule with the URSP rule from the PCF. The preconfigured URSP rule may have a lower priority than the URSP rule from the PCF.

In some implementations, by configuring the byte in the UE policy section management sub-list, the PCF may be able to instruct the UE to keep preconfigured URSP rules of the UE, even after receiving URSP rules from the PCF. Alternatively, the PCF may be able to instruct the UE to ignore the preconfigured URSP rules and only use the URSP rules from the PCF. The preconfigured URSP rules may be different for different types of UEs based on different chipset vendors, and the PCF may be unaware of a type of UE used by a subscriber. An ability to indicate whether the UE should ignore the preconfigured URSP rules or keep the preconfigured URSP rules, along with priority information, may improve an overall system performance.

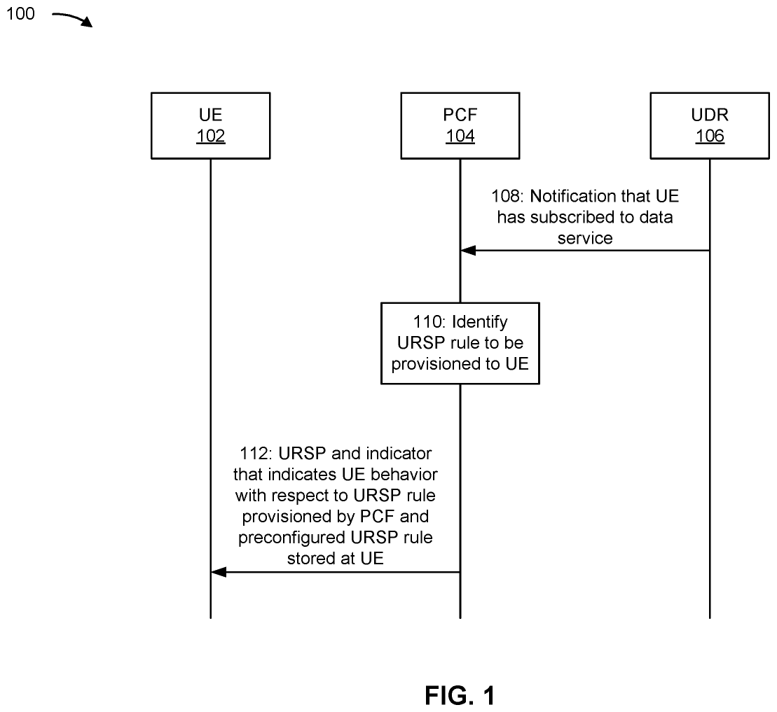

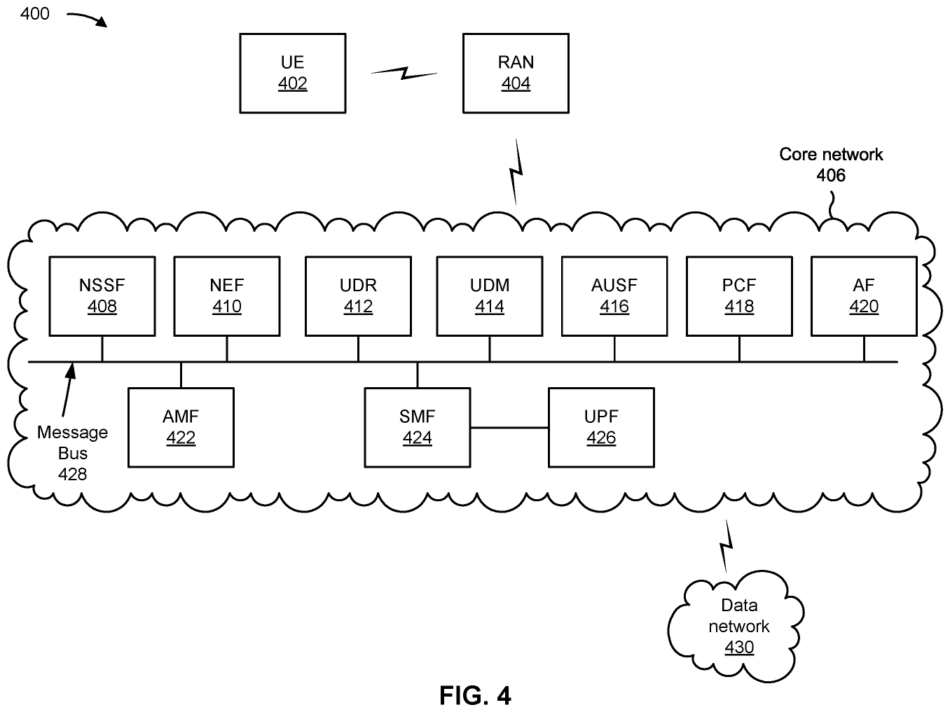

FIG. 1 is a diagram of an example 100 associated with handling URSP rules. As shown in FIG. 1, example 100 includes a UE 102, a PCF 104, and a UDR 106. The UE 102, the PCF 104, and the UDR 106 may correspond to UE 402, PCF 418, and UDR 412, respectively, as shown in FIG. 4.

As shown by reference number 108, the UDR 106 may transmit, to the PCF 104, a notification that the UE 102 has subscribed to a data service. A subscriber associated with the UE 102 may sign up for the data service, such as a premium data service. The UDR 106 may provision the data service into a data store associated with the UDR 106. The UDR 106 may notify the PCF 104 that the subscriber signed up for the data service.

As shown by reference number 110, the PCF 104 may identify a URSP rule to be provisioned for the UE 102. The PCF 104 may identify the URSP rule based on the notification received from the PCF 104. For example, the PCF 104 may identify a URSP rule associated with the data service based on the notification received from the PCF 104.

As shown by reference number 112, the PCF 104 may transmit, to the UE 102, the URSP rule and an indicator. The indicator may indicate a UE behavior with respect to the URSP rule provisioned by the PCF 104 and a preconfigured URSP rule stored at the UE 102. In some implementations, the indicator may be set to a first value to indicate that the UE 102, in accordance with the UE behavior, is to ignore the preconfigured URSP rule and consider the URSP rule provisioned by the PCF 104. The indicator may be set to a second value to indicate that the UE 102, in accordance with the UE behavior, is to combine the preconfigured URSP rule and the URSP rule provisioned by the PCF 104. The preconfigured URSP rule may be associated with a higher priority than the URSP rule provisioned by the PCF 104. The indicator may be set to a third value to indicate that the UE 102, in accordance with the UE behavior, is to combine the preconfigured URSP rule and the URSP rule provisioned by the PCF 104. The preconfigured URSP rule may be associated with a lower priority than the URSP rule provisioned by the PCF 104.

In some implementations, the UE 102, after receiving the URSP and the indicator, may check a value associated with the indicator and perform the UE behavior accordingly. For example, depending on the value, the UE 102 may ignore the preconfigured URSP rule, or the UE 102 may keep both the preconfigured URSP rule and the URSP rule provisioned by the PCF 104. When the UE 102 determines to keep both the preconfigured URSP rule and the URSP rule provisioned by the PCF 104, a priority between the preconfigured URSP rule and the URSP rule provisioned by the PCF 104 may be determined by the value.

In some implementations, the PCF 104 may provide the indicator in a UE policy section management sub-list of a URSP data structure. The preconfigured URSP rule stored at the UE 102 may not be automatically ignored in response to a receipt of the URSP rule provisioned by the PCF 104. Rather, the UE 102 may determine whether to ignore the preconfigured URSP rule, or keep both the preconfigured URSP rule and the URSP rule provisioned by the PCF 104. The preconfigured URSP rule may be UE-specific. For example, the preconfigured URSP rule may be specific to the UE 102. A specific UE type may be unknown to the PCF 104. For example, the PCF 104 may be unaware of whether the UE 102 is manufactured by a first manufacturer or a second manufacturer, where different manufacturers may be associated with different preconfigured URSP rules.

In some implementations, in a URSP data structure, a URSP may include the UE policy section management sub-list, and a byte may be added to the UE policy section management sub-list. The PCF 104 may set a value of the byte before the PCF 104 provides the URSP to the UE 102. The UE 102, after receiving the URSP, may check the value of the byte. When the byte is set to the first value (e.g., “00000000”), the UE 102 may ignore the preconfigured URSP rule and only use the URSP rule from the PCF 104 (e.g., the URSP rule pushed by the PCF 104). In other words, when the byte is set to the first value, the UE 102 may override the preconfigured URSP rule with the URSP rule from the PCF 104. When the byte is set to the second value (e.g., “00000001”), the UE 102 may combine the preconfigured URSP rule with the URSP rule from the PCF 104. The preconfigured URSP rule may have a higher priority than the URSP rule from the PCF 104. When the byte is set to the third value (e.g., “00000010”), the UE 102 may combine the preconfigured URSP rule with the URSP rule from the PCF 104. The preconfigured URSP rule may have a lower priority than the URSP rule from the PCF 104.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

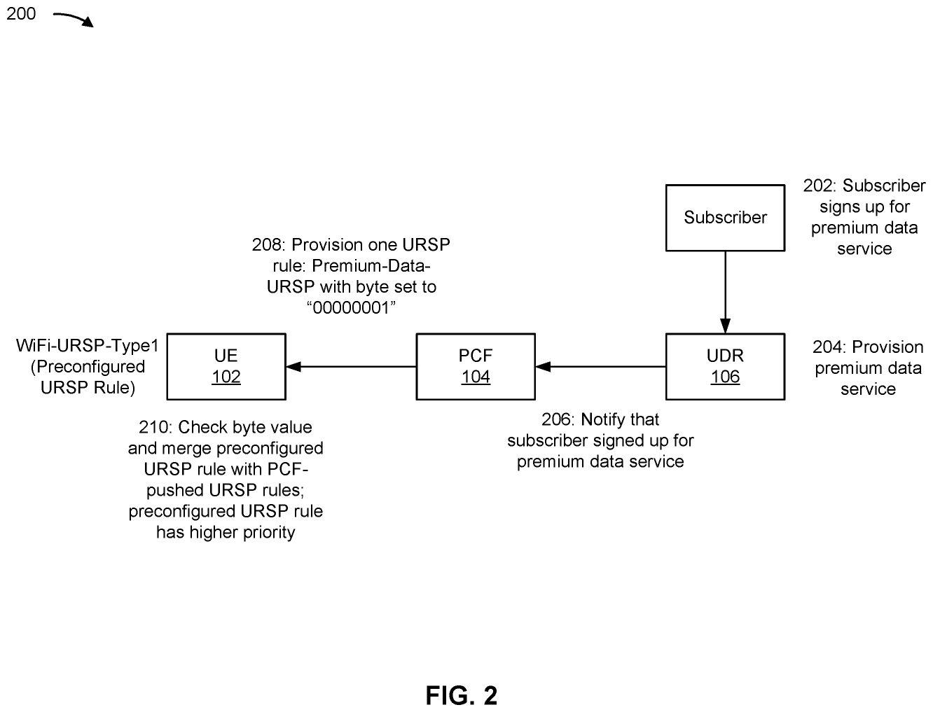

FIG. 2 is a diagram of an example 200 associated with handling URSP rules. As shown in FIG. 2, example 200 includes a UE 102, a PCF 104, and a UDR 106. The UE 102, the PCF 104, and the UDR 106 may correspond to UE 402, PCF 418, and UDR 412, respectively, as shown in FIG. 4.

As shown by reference number 202, a subscriber may sign up for a premium data service. As shown by reference number 204, the UDR 106 may provision the premium data service into a data store associated with the UDR 106. As shown by reference number 206, the UDR 106 may notify the PCF 104 that the subscriber signed up for the premium data service. As shown by reference number 208, the PCF 104 may provision one URSP rule to the UE 102. The URSP rule may be a Premium-Data-URSP rule. The URSP rule may include a byte with a value set to “00000001”. The UE 102 may have a preconfigured URSP rule associated with WiFi calling. The preconfigured URSP rule may be a WiFi-URSP rule. As shown by reference number 210, after the UE 102 receives the URSP rule from the PCF 104, the UE 102 may check the value indicated in the URSP rule. Based on the value of “00000001”, the UE 102 may combine the preconfigured WiFi-URSP rule and the Premium-Data-URSP rule pushed by the PCF 104. In this case, the preconfigured WiFi-URSP rule may have a higher priority than the Premium-Data-URSP rule.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

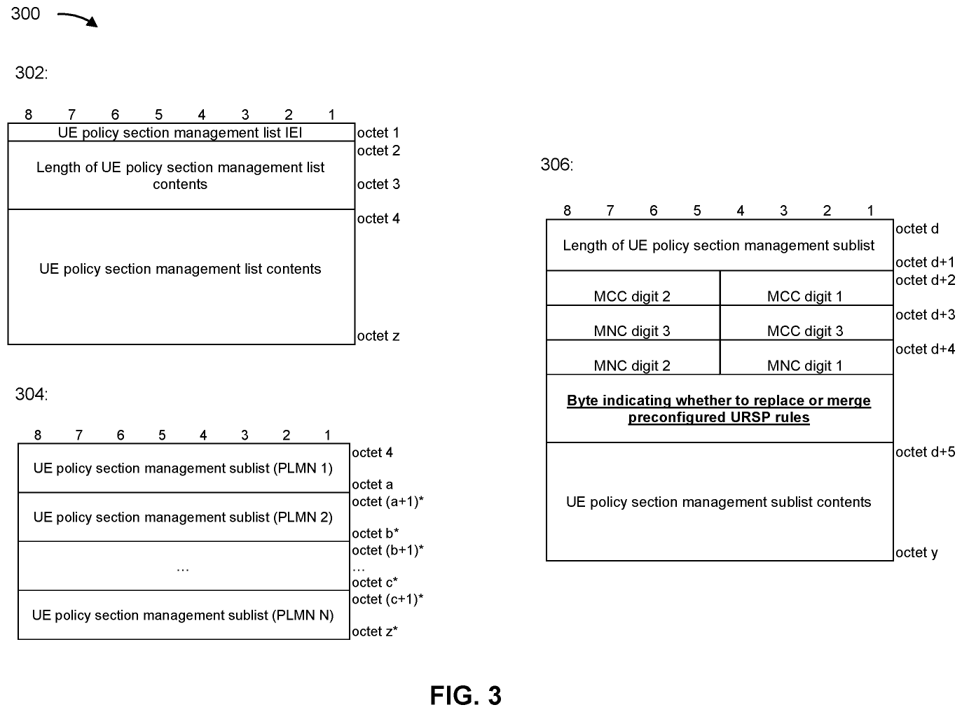

FIG. 3 is a diagram of an example 300 associated with a URSP data structure.

As shown by reference number 302, the URSP data structure may include UE policy section management list information element (IE). The UE policy section management list IE may include UE policy section management list contents. As shown by reference number 304, in the URSP data structure, the UE policy section management list contents may include a plurality of UE policy section management sub-lists. As shown by reference number 306, in the URSP data structure, a UE policy section management sub-list, of the plurality of UE policy section management sub-lists, may include a byte. When the byte is set to a first value (e.g., “00000000”), a UE may ignore a preconfigured URSP rule and only use a URSP rule from a PCF. When the byte is set to a second value (e.g., “00000001”), the UE may combine the preconfigured URSP rule with the URSP rule from the PCF. The preconfigured URSP rule may have a higher priority than the URSP rule from the PCF. When the byte is set to a third value (e.g., “00000010”), the UE may combine the preconfigured URSP rule with the URSP rule from the PCF. The preconfigured URSP rule may have a lower priority than the URSP rule from the PCF.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 is a diagram of an example environment 400 in which systems and/or methods described herein may be implemented. As shown in FIG. 4, example environment 400 may include a UE 402, a radio access network (RAN) 404, a core network 406, and a data network 430. Devices and/or networks of example environment 400 may interconnect via wired connections, wireless connections, or a combination of wired and wireless connections.

The UE 402 may include one or more devices capable of receiving, generating, storing, processing, and/or providing information, such as information described herein. For example, the UE 402 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 404 may support, for example, a cellular radio access technology (RAT). The RAN 404 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 402. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 404 may transfer traffic between the UE 402 (e.g., using a cellular RAT), one or more base stations (e.g., using a wireless interface or a backhaul interface, such as a wired backhaul interface), and/or the core network 406. The RAN 404 may provide one or more cells that cover geographic areas.

In some implementations, the RAN 404 may perform scheduling and/or resource management for the UE 402 covered by the RAN 404 (e.g., the UE 402 covered by a cell provided by the RAN 404). In some implementations, the RAN 404 may be controlled or coordinated by a network controller, which may perform load balancing, network-level configuration, and/or other operations. The network controller may communicate with the RAN 404 via a wireless or wireline backhaul. In some implementations, the RAN 404 may include a network controller, a self-organizing network (SON) module or component, or a similar module or component. In other words, the RAN 404 may perform network control, scheduling, and/or network management functions (e.g., for uplink, downlink, and/or sidelink communications of the UE 402 covered by the RAN 404).

In some implementations, the core network 406 may include an example functional architecture in which systems and/or methods described herein may be implemented. For example, the core network 406 may include an example architecture of a 5G next generation (NG) core network included in a 5G wireless telecommunications system. While the example architecture of the core network 406 shown in FIG. 4 may be an example of a service-based architecture, in some implementations, the core network 406 may be implemented as a reference-point architecture and/or a 4G core network, among other examples.

As shown in FIG. 4, the core network 406 may include a number of functional elements. The functional elements may include, for example, a network slice selection function (NSSF) 408, a network exposure function (NEF) 410, a UDR 412, a unified data management (UDM) 414, an authentication server function (AUSF) 416, a PCF 418, an application function (AF) 420, an access and mobility management function (AMF) 422, a session management function (SMF) 424, and/or a user plane function (UPF) 426. These functional elements may be communicatively connected via a message bus 428. Each of the functional elements shown in FIG. 4 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 408 may include one or more devices that select network slice instances for the UE 402. The NSSF 408 may allow an operator to deploy multiple substantially independent end-to-end networks potentially with the same infrastructure. In some implementations, each slice may be customized for different services. The NEF 410 may include one or more devices that support exposure of capabilities and/or events in the wireless telecommunications system to help other entities in the wireless telecommunications system discover network services.

The UDR 412 may include one or more devices that provide a converged repository, which may be used by network functions to store data. For example, a converged repository of subscriber information may be used to service a number of network functions. The UDM 414 may include one or more devices to store user data and profiles in the wireless telecommunications system. The UDM 414 may generate authentication vectors, perform user identification handling, perform subscription management, and perform other various functions. The AUSF 416 may include one or more devices that act as an authentication server and support the process of authenticating the UE 402 in the wireless telecommunications system.

The PCF 418 may include one or more devices that provide a policy framework that incorporates network slicing, roaming, packet processing, and/or mobility management, among other examples. The AF 420 may include one or more devices that support application influence on traffic routing, access to the NEF 410, and/or policy control, among other examples. The AMF 422 may include one or more devices that act as a termination point for non-access stratum (NAS) signaling and/or mobility management, among other examples. The SMF 424 may include one or more devices that support the establishment, modification, and release of communication sessions in the wireless telecommunications system. For example, the SMF 424 may configure traffic steering policies at the UPF 426 and/or may enforce UE IP address allocation and policies, among other examples. The UPF 426 may include one or more devices that serve as an anchor point for intra-RAT and/or inter-RAT mobility. The UPF 426 may apply rules to packets, such as rules pertaining to packet routing, traffic reporting, and/or handling user plane QoS, among other examples. The message bus 428 may represent a communication structure for communication among the functional elements. In other words, the message bus 428 may permit communication between two or more functional elements.

The data network 430 may include one or more wired and/or wireless data networks. For example, the data network 430 may include an Internet Protocol multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example environment 400 may perform one or more functions described as being performed by another set of devices of example environment 400.

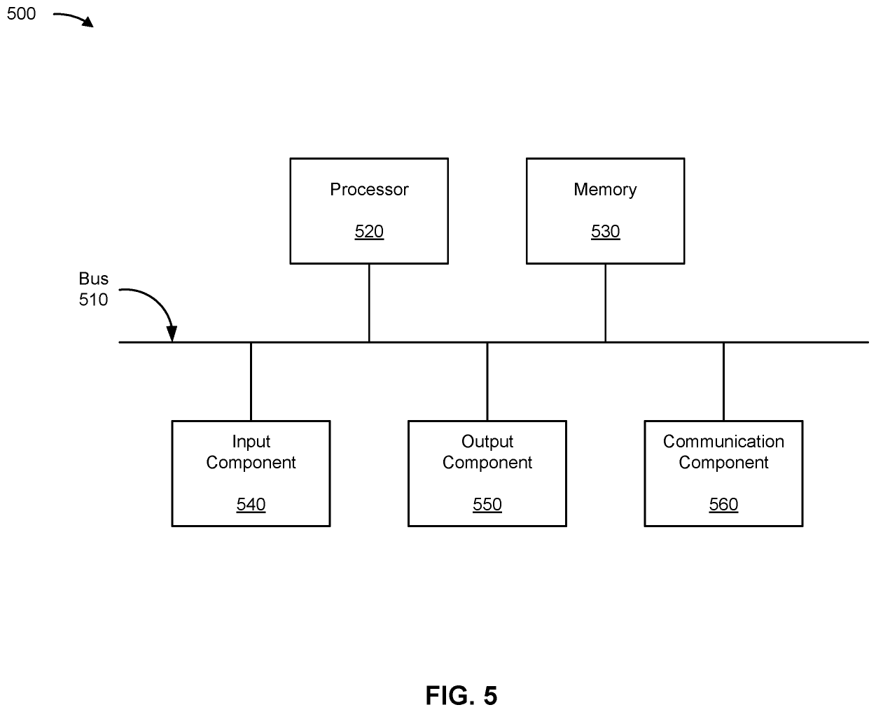

FIG. 5 is a diagram of example components of a device 500 associated with handling URSP rules. The device 500 may correspond to a PCF (e.g., PCF 104/418). In some implementations, the PCF may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

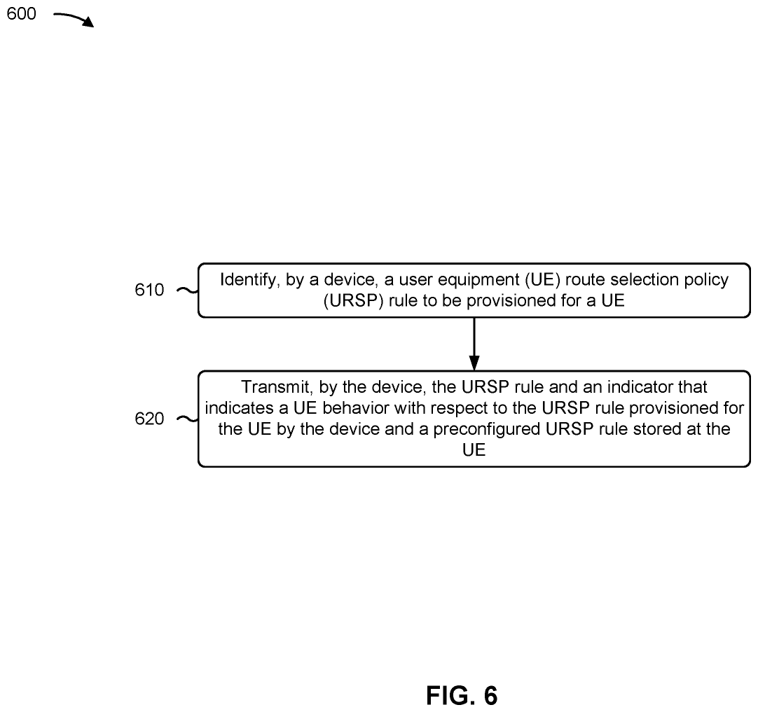

FIG. 6 is a flowchart of an example process 600 associated with handling URSP rules. In some implementations, one or more process blocks of FIG. 6 may be performed by a device (e.g., PCF 104/418). In some implementations, one or more process blocks of FIG. 6 may be performed by another entity or a group of entities separate from or including the device. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include identifying, by the device, a URSP rule to be provisioned for a UE (block 610). In some implementations, the device may receive a notification that the UE has subscribed to a data service (e.g., a premium data service), and the URSP rule to be provisioned for the UE may be based on the notification. For example, the URSP rule may be associated with the data service.

As shown in FIG. 6, process 600 may include transmitting, by the device, the URSP rule and an indicator (block 620). The indicator may indicate a UE behavior with respect to the URSP rule provisioned for the UE by the device and a preconfigured URSP rule stored at the UE. In some implementations, the indicator may be set to a first value to indicate that the UE, in accordance with the UE behavior, is to ignore the preconfigured URSP rule and consider the URSP rule provisioned for the UE by the device. The indicator may be set to a second value to indicate that the UE, in accordance with the UE behavior, is to combine the preconfigured URSP rule and the URSP rule provisioned for the UE by the device, and the preconfigured URSP rule is associated with a higher priority than the URSP rule provisioned for the UE by the device. The indicator may be set to a third value to indicate that the UE, in accordance with the UE behavior, is to combine the preconfigured URSP rule and the URSP rule provisioned for the UE by the device, and the preconfigured URSP rule is associated with a lower priority than the URSP rule provisioned for the UE by the device.

In some implementations, the indicator may be provided in a UE policy section management sub-list of a URSP data structure. The preconfigured URSP rule stored at the UE may not be automatically ignored in response to a receipt of the URSP rule provisioned for the UE by the device. The preconfigured URSP rule may be UE-specific, and a specific UE type may be unknown to the device. The device may be a PCF device in a wireless network. The notification may be received from a UDR device in the wireless network.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a device, a user equipment (UE) route selection policy (URSP) rule to be provisioned for a UE; and
transmitting, by the device, the URSP rule and an indicator, wherein the indicator indicates a UE behavior with respect to the URSP rule provisioned for the UE by the device and a preconfigured URSP rule stored at the UE.

2. The method of claim 1, wherein the indicator is set to a first value to indicate that the UE, in accordance with the UE behavior, is to ignore the preconfigured URSP rule and consider the URSP rule provisioned for the UE by the device.

3. The method of claim 1, wherein the indicator is set to a second value to indicate that the UE, in accordance with the UE behavior, is to combine the preconfigured URSP rule and the URSP rule provisioned for the UE by the device, and the preconfigured URSP rule is associated with a higher priority than the URSP rule provisioned for the UE by the device.

4. The method of claim 1, wherein the indicator is set to a third value to indicate that the UE, in accordance with the UE behavior, is to combine the preconfigured URSP rule and the URSP rule provisioned for the UE by the device, and the preconfigured URSP rule is associated with a lower priority than the URSP rule provisioned for the UE by the device.

5. The method of claim 1, wherein the indicator is provided in a UE policy section management sub-list of a URSP data structure.

6. The method of claim 1, wherein the preconfigured URSP rule stored at the UE is not automatically ignored in response to a receipt of the URSP rule provisioned for the UE by the device.

7. The method of claim 1, wherein the preconfigured URSP rule is UE-specific.

8. The method of claim 1, wherein the device is a policy control function (PCF) device in a wireless network.

9. A device, comprising:
one or more processors configured to:
receive a notification that a user equipment (UE) has subscribed to a data service; and
transmit, based on the notification, a UE route selection policy (URSP) rule associated with the data service and an indicator, wherein the indicator indicates a UE behavior with respect to the URSP rule associated with the data service and a preconfigured URSP rule stored at the UE.

10. The device of claim 9, wherein the indicator is set to a first value to indicate that the UE, in accordance with the UE behavior, is to ignore the preconfigured URSP rule and consider the URSP rule associated with the data service.

11. The device of claim 9, wherein the indicator is set to a second value to indicate that the UE, in accordance with the UE behavior, is to combine the preconfigured URSP rule and the URSP rule associated with the data service, and the preconfigured URSP rule is associated with a higher priority than the URSP rule associated with the data service.

12. The device of claim 9, wherein the indicator is set to a third value to indicate that the UE, in accordance with the UE behavior, is to combine the preconfigured URSP rule and the URSP rule associated with the data service, and the preconfigured URSP rule is associated with a lower priority than the URSP rule associated with the data service.

13. The device of claim 9, wherein the indicator is provided in a UE policy section management sub-list of a URSP data structure.

14. The device of claim 9, wherein the preconfigured URSP rule stored at the UE is not automatically ignored in response to a receipt of the URSP rule associated with the data service.

15. The device of claim 9, wherein the preconfigured URSP rule is UE-specific.

16. The device of claim 9, wherein the device is a policy control function (PCF) device in a wireless network, and the notification is received from a unified data repository (UDR) device in the wireless network.

17. A non-transitory computer-readable medium storing a set of instructions, the set of instructions comprising:
one or more instructions that, when executed by one or more processors of a device, cause the device to:
identify a user equipment (UE) route selection policy (URSP) rule to be provisioned for a UE; and
transmit the URSP rule and an indicator, wherein the indicator indicates a UE behavior with respect to the URSP rule provisioned for the UE by the device and a preconfigured URSP rule stored at the UE.

18. The non-transitory computer-readable medium of claim 17, wherein:
the indicator is set to a first value to indicate that the UE, in accordance with the UE behavior, is to ignore the preconfigured URSP rule and consider the URSP rule provisioned for the UE by the device;
the indicator is set to a second value to indicate that the UE, in accordance with the UE behavior, is to combine the preconfigured URSP rule and the URSP rule provisioned for the UE by the device, and the preconfigured URSP rule is associated with a higher priority than the URSP rule provisioned for the UE by the device; or
the indicator is set to a third value to indicate that the UE, in accordance with the UE behavior, is to combine the preconfigured URSP rule and the URSP rule provisioned for the UE by the device, and the preconfigured URSP rule is associated with a lower priority than the URSP rule provisioned for the UE by the device.

19. The non-transitory computer-readable medium of claim 17, wherein the indicator is provided in a UE policy section management sub-list of a URSP data structure, and the device is a policy control function (PCF) device in a wireless network.

20. The non-transitory computer-readable medium of claim 17, wherein:
the preconfigured URSP rule stored at the UE is not automatically ignored in response to a receipt of the URSP rule provisioned for the UE by the device; and
the preconfigured URSP rule is UE-specific.
